(19) United States
(12) Patent Application Publication
(10) Pub. No.: US 2020/0326888 A1
(43) Pub. Date: Oct. 15, 2020

(54) SUPPRESSION OF TIMEOUT OCCURRENCE DURING A DATA READING OPERATION

(71) Applicant: FUJITSU LIMITED, Kawasaki-shi (JP)

(72) Inventors: REISUKE NAKAGAWA, Inagi (JP); Maki Matsubara, Kawasaki (JP)

(73) Assignee: FUJITSU LIMITED, Kawasaki-shi (JP)

(21) Appl. No.: 16/842,893

(22) Filed: Apr. 8, 2020

(30) Foreign Application Priority Data
Apr. 15, 2019 (JP) 2019-077071

(51) Int. Cl. G06F 3/06

(52) U.S. Cl. CPC G06F 3/0659; G06F 3/0644; G06F 3/0683; G06F 3/0619; G06F 3/0652

(57) ABSTRACT

An apparatus, in response to a data write request, writes target data to a first memory. During data movement from the first memory to a second memory, the apparatus stores first data included in the target data in the first memory, stores second data obtained by excluding the first data from the target data in the second memory, and deletes the second data from the first memory. In response to a data read request from a data requesting source, the apparatus reads the first data from the first memory and transfers the first data to the data requesting source while moving the second data from the second memory to the first memory. After completion of transferring the first data to the data requesting source, the apparatus transfers from the first memory to the data requesting source, the second data that has been moved to the first memory

### CROSS-REFERENCE TO RELATED APPLICATION

This application is based upon and claims the benefit of priority of the prior Japanese Patent Application No. 2019-77071, filed on Apr. 15, 2019, the entire contents of which are incorporated herein by reference.

### FIELD

The embodiments discussed herein are related to suppression of time out occurrence during a data reading operation.

### BACKGROUND

A storage system has storage devices and stores and manages a large amount of data to be handled in information processing. In recent years, a storage system has captured attention that has an archive function saving data that is less frequently used but is required to be kept for a long period of time without deleting from a high-speed access storage to a low speed access storage.

Such a storage system includes a primary storage and a secondary storage that are layered, and, data stored in the primary storage configured by a solid-state drive (SSD), for example, is moved to the secondary storage configured by a tape. The secondary storage stores the data moved from the primary storage as archive data (save data).

As related art, a technology has been proposed in which, for example, a storage device maintains a head portion of data and transmits the maintained data to an upper apparatus and a storage device having a lower read speed than the storage device transmits data subsequent to the head portion to the upper apparatus. Another technology has been proposed in which a communication apparatus simultaneously calls data in a plurality of regions in a file to be downloaded from a host server, downloads a plurality of data pieces in parallel and stores them in regions of a generated storage file.

Japanese Laid-open Patent Publication No. 2008-83845 and International Publication Pamphlet No. WO 2017/126105 are examples of related art.

### SUMMARY

According to an aspect of the embodiments, an apparatus, in response to a data write request, writes target data to a first memory. During data movement from the first memory to a second memory, the apparatus stores first data included in the target data in the first memory, stores second data obtained by excluding the first data from the target data in the second memory, and deletes the second data from the first memory. In response to a data read request from a data requesting source, the apparatus reads the first data from the first memory and transfers the first data to the data requesting source while moving the second data from the second memory to the first memory. After completion of transferring the first data to the data requesting source, the apparatus transfers from the first memory to the data requesting source, the second data that has been moved to the first memory

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for explaining an example of a storage apparatus;

FIG. 2 is a diagram illustrating an example of a configuration of a storage system;

FIG. 3 is a diagram illustrating an example of a hardware configuration of a storage control unit;

FIG. 4 is a diagram illustrating an example of a configuration of functional blocks;

FIG. 5 is a flowchart illustrating an example of a data transfer operation in an archive division mode;

FIG. 6 is a flowchart illustrating an example of a writing operation in the archive division mode;

FIG. 7 is a flowchart illustrating an example of a reading operation in the archive division mode;

FIG. 8 is a diagram for explaining an example of a writing operation;

FIG. 9 is a diagram for explaining the example of the writing operation;

FIG. 10 is a diagram for explaining the example of the writing operation;

FIG. 11 is a diagram for explaining an example of a reading operation;

FIG. 12 is a diagram for explaining the example of the reading operation;

FIG. 13 is a diagram for explaining the example of the reading operation;

FIG. 14 is a flowchart illustrating an example of a data transfer operation in a recall division mode;

FIG. 15 is a flowchart illustrating an example of a writing operation in the recall division mode;

FIG. 16 is a flowchart illustrating an example of a reading operation in the recall division mode;

FIG. 17 is a diagram for explaining an example of a writing operation;

FIG. 18 is a diagram for explaining the example of the writing operation;

FIG. 19 is a diagram for explaining an example of a reading operation;

FIG. 20 is a diagram for explaining the example of the reading operation;

FIG. 21 is a flowchart illustrating an example of an operation from transfer of a head data piece to reconstruction of target data;

FIG. 22 is a diagram illustrating an example of data transfer (in a case where a tape is used); and

FIG. 23 is a diagram illustrating an example of data transfer (in a case where a disk is used).

### DESCRIPTION OF EMBODIMENTS

In the storage system as described above, when archive data is read out, the archive data is read out from the primary storage after the movement of the entire data from the secondary storage to the primary storage completes. A predetermined time is defined for the data reading, and the data reading is required to start within the predetermined time. However, when the data movement from the secondary storage to the primary storage takes time, the data reading is not started within the predetermined time, possibly causing a timeout.

According to one aspect, it is desirable to suppress occurrence of a timeout while a data reading operation is being performed.

Embodiments will be described below with reference to the accompanying drawings.

### First Embodiment

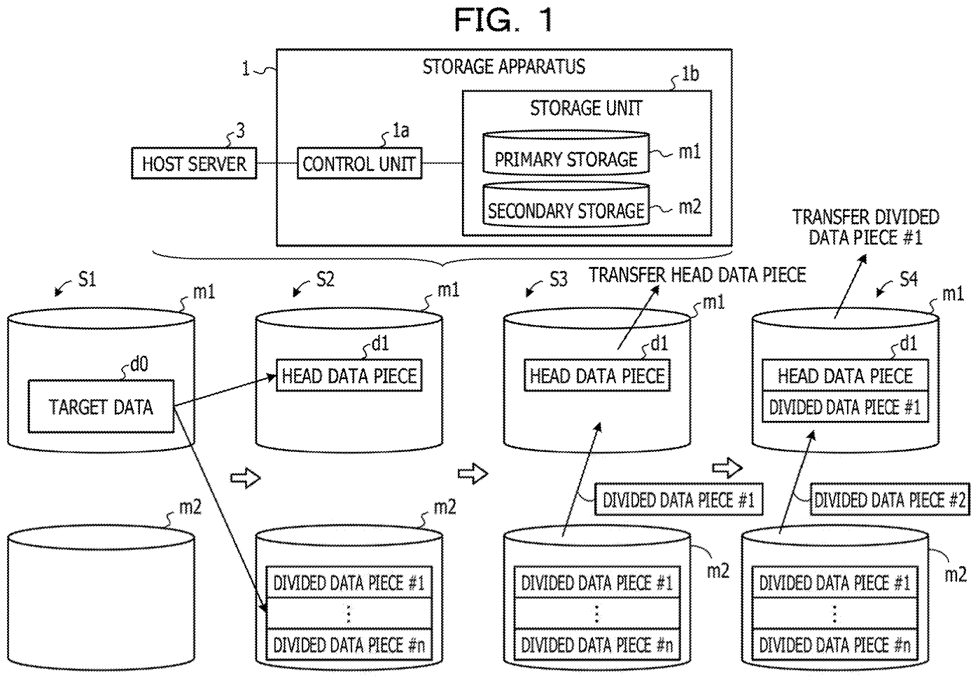

A first embodiment will be described with reference to FIG. 1. FIG. 1 is a diagram for explaining an example of a storage apparatus. A storage apparatus 1 includes a control unit 1a and a storage unit 1b, and the storage unit 1b includes a primary storage m1 (first storage device) and a secondary storage m2 (second storage device). A host server 3 is coupled to the storage apparatus 1.

In response to a data write request from the host server 3, the control unit 1a writes target data d0 in the primary storage m1. For data movement from the primary storage m1 to the secondary storage m2, the control unit 1a stores a first data piece of the target data do in the primary storage m1 and at least stores a second data piece excluding the first data piece from the target data d0 in the secondary storage m2. Not only the second data piece but also the first data piece may be stored in the secondary storage m2. (In other words, for example, the target data d0 may be stored in the secondary storage m2).

In response to a data read request from the host server 3, the control unit 1a reads out the first data piece from the primary storage m1 and transfers it to the data requesting source and moves the second data piece from the secondary storage m2 to the primary storage m1. After the transfer of the first data piece, the second data piece moved to the primary storage m1 is transferred to the data requesting source.

An operation will be described by using the example illustrated in FIG. 1.

[Step S1] In response to a data write request from the host server 3, the control unit 1a writes and stores target data d0 in the primary storage m1.

[Step S2] The control unit 1a divides the target data d0 into data pieces each having a predetermined size when the target data d0 is moved from the primary storage m1 to the secondary storage m2. The control unit 1a stores a head data piece d1 of the data pieces acquired by dividing the target data d0 in the primary storage m1 and stores the divided data piece group (divided data pieces #1, . . . , # n) excluding the head data piece d1 in the secondary storage m2.

[Step S3] In response to a data read request from the host server 3, the control unit 1a reads out the head data piece d1 from the primary storage m1 and transfers it to the host server 3. In parallel with the transfer of the head data piece d1 to the host server 3, the control unit 1a copies and moves the divided data piece #1 of the divided data piece group stored in the secondary storage m2 from the secondary storage m2 to the primary storage m1.

[Step S4] After the transfer of the head data piece d1, the control unit 1a reads out, from the primary storage m1, the divided data piece #1 moved to the primary storage m1 and transfers it to the host server 3. In parallel with the transfer of the divided data piece #1 to the host server 3, the control unit 1a copies and moves the divided data piece #2 of the divided data piece group stored in the secondary storage m2 from the secondary storage m2 to the primary storage m1. Subsequently, in the same manner, the divided data pieces moved from the secondary storage m2 to the primary storage m1 are sequentially transferred to the host server 3.

As described above, in the storage apparatus 1, a first data piece of the target data d0 is stored in the primary storage m1, and the remaining second data piece excluding the first data piece is at least stored in the secondary storage m2. In parallel with the transfer of the first data piece to the host server 3, the storage apparatus 1 moves the second data piece from the secondary storage m2 to the primary storage m1 and sequentially transfers the second data piece moved to the primary storage m1 to the host server 3.

Thus, in response to a data read request from the host server 3, a data readout is started within a predetermined time, and data are transferred to the host server 3 without a break of the data. Therefore, occurrence of a timeout while the data is being read may be suppressed.

### Second Embodiment

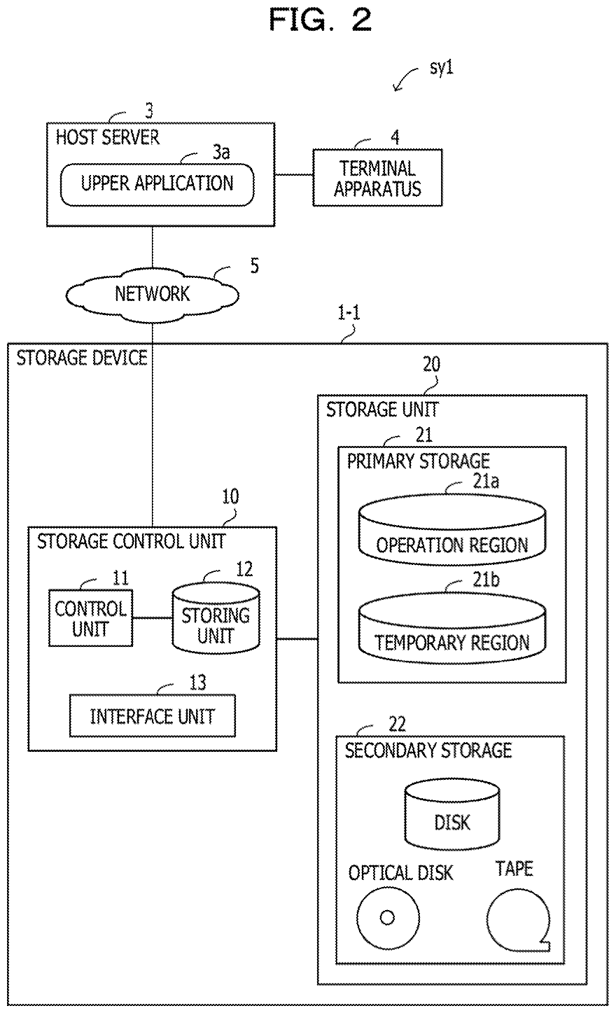

Next, a second embodiment will be described. FIG. 2 illustrates an example of a configuration of a storage system. A storage system sy1 includes a storage apparatus 1-1, a host server 3, and a terminal apparatus 4. The terminal apparatus 4 that performs maintenance and operation management is coupled to the host server 3, and the host server 3 and the storage apparatus 1-1 are coupled through a network 5.

The storage apparatus 1-1 includes a storage control unit 10 and a storage unit 20. The storage unit 20 includes a primary storage 21 and a secondary storage 22.

The primary storage 21 is configured by a recording medium from and to which data may be read and written at a higher speed than the secondary storage 22. For example, the primary storage 21 is a hard disk drive (HDD) or an SSD.

The primary storage 21 has an operation region 21a and a temporary region 21b. In the operation region 21a, target data (real data) and a head data piece of divided data pieces of the target data are stored, for example. In the temporary region 21b, all of the divided data pieces of the target data are stored, for example. In a case where target data is stored in files, file information, which will be described below, is stored in the operation region 21a or the temporary region 21b. Usage examples of the operation region 21a and the temporary region 21b will be described below.

The secondary storage 22 is configured by a recording medium from and to which data may be read and written at a lower speed than the primary storage 21. The secondary storage 22 is an HDD, an optical disk or a tape, for example.

The storage control unit 10 includes a control unit 11, a storing unit 12 and an interface unit 13 and performs I/O control on the storage unit 20 in accordance with an instruction from an upper application 3a in the host server 3.

The control unit 11 has functionality of the control unit 1a illustrated in FIG. 1. The control unit 11 moves data from the primary storage 21 to the secondary storage 22 or from the secondary storage 22 to the primary storage 21 and performs layering management on the primary storage 21 and the secondary storage 22 (data rearrangement between the primary storage 21 and the secondary storage 22).

The storing unit 12 stores setting information (such as a data division size and the number of data pieces that may be read or written simultaneously), which will be described below, relating to the data rearrangement between the storages and stores control information and so on regarding operation management of the entire storage apparatus 1-1. The interface unit 13 performs interface control with the host server 3 through the network 5 or performs interface control with the storage unit 20.

<Hardware>

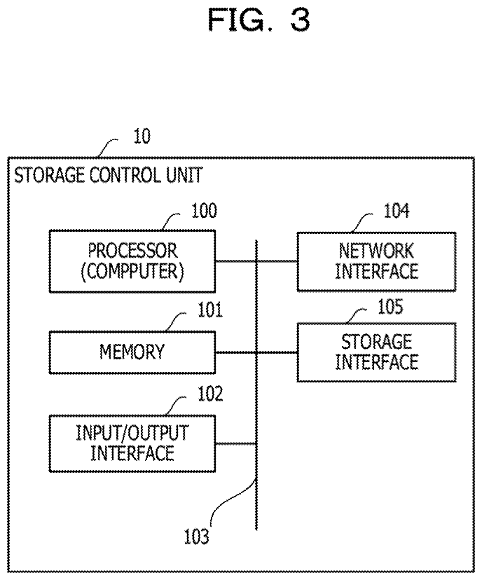

FIG. 3 is a diagram illustrating an example of a hardware configuration of the storage control unit. The storage control unit 10 is entirely controlled by a processor (computer) 100. In other words, for example, the processor 100 functions as a control unit of the storage control unit 10. A memory 101 and a plurality of peripheral devices are coupled with the processor 100 via a bus 103. The processor 100 may be a multiprocessor. The processor 100 is, for example, a central processing unit (CPU), a microprocessor unit (MPU), a digital signal processor (DSP), an application specific integrated circuit (ASIC), or a programmable logic device (PLD). The processor 100 may be a combination of two or more elements of the CPU, MPU, DSP, ASIC, and PLD.

The memory 101 is used as a main storage device for the storage control unit 10. At least some of programs of an operating system (OS) and application programs, that are executed by the processor 100, are temporarily stored in the memory 101. The memory 101 also stores various kinds of data required in processing by the processor 100.

The memory 101 is also used as an auxiliary storage device for the storage control unit 10, and stores the programs of the OS, the application programs, and the various kinds of data. The memory device 101 may include, as an auxiliary storage device, a semiconductor storage device, such as a flash memory or an SSD, and/or a magnetic recording medium, such as an HDD.

The peripheral devices coupled with the bus 103 include an input/output interface 102, a network interface 104, and a storage interface 105. The input/output interface 102 is coupled with a monitor (such as a light emitting diode (LED), a liquid crystal display (LCD)) that functions as a display device for displaying a state of the storage control unit 10 in accordance with an instruction from the processor 100.

The input/output interface 102 may be coupled with an information input device such as a keyboard or a mouse, and transmits a signal transmitted from the information input device to the processor 100.

The input/output interface 102 also functions as a communication interface for coupling the peripheral devices. For example, the input/output interface 102 may be coupled with an optical drive device that reads data recorded on an optical disk by using laser light or the like. Examples of the optical disk include a Blu-ray Disc (registered trademark), a compact disc read-only memory (CD-ROM), a CD-recordable (R)/rewritable (RW), and the like.

The input/output interface 102 may be also coupled with a memory device or a memory reader/writer. The memory device is a recording medium having a function of communicating with the input/output interface 102. The memory reader/writer is a device for writing data to a memory card or reading data from a memory card. A memory card is a card type recording medium.

The network interface 104 performs communication interface control with respect to the network 5 and may also be implemented as, for example, a network interface card (NIC), a wireless local area network (LAN) card, or the like. Data received by the network interface 104 is outputted to the memory 101 and the processor 100.

The storage interface 105 performs interface control with respect to the storage unit 20 and controls transmission and reception of data, file information and so on to and from the storage unit 20.

With a hardware configuration as described above, it is possible to realize processing functions of the storage control unit 10. For example, the storage control unit 10 may perform control according to the embodiments by the processor 100 executing each of predetermined programs.

In the storage control unit 10, for example, the processing functions in the embodiments may be realized by executing a program recorded in a computer-readable recording medium. A program in which details of processing to be executed by the storage control unit 10 are written may be recorded in/on various recording media.

For example, the program to be executed by the storage control unit 10 may be stored in an auxiliary storage device. The processor 100 loads at least some of the programs within the auxiliary storage device to the main storage device and executes a program.

Recording may be performed in a portable recording medium such as an optical disk, a memory device, or a memory card. A program stored in the portable recording medium becomes executable after being installed in, for example, the auxiliary storage device, under control of the processor 100. The processor 100 may read and execute a program directly from the portable recording medium.

<Functional Block>

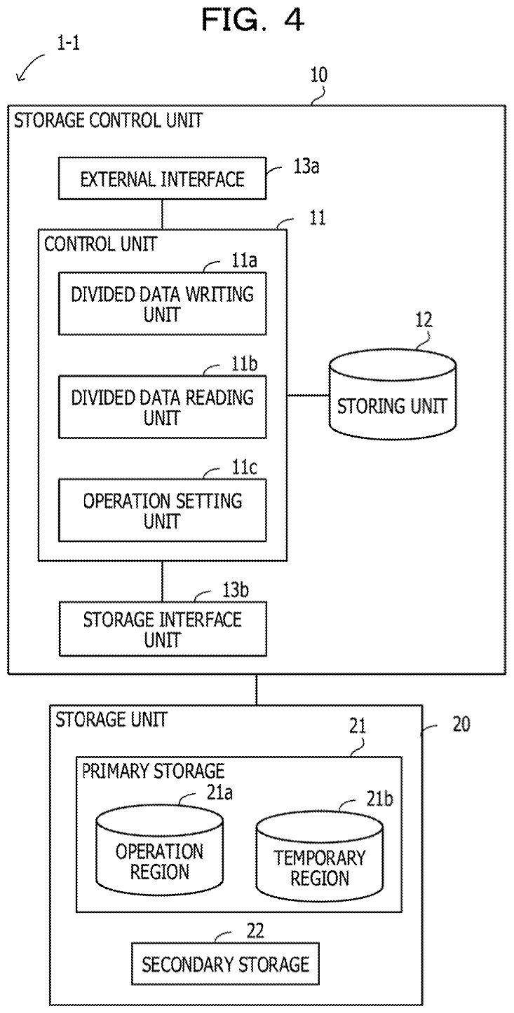

FIG. 4 is a diagram illustrating an example of a configuration of functional blocks. The storage control unit 10 includes the control unit 11, the storing unit 12, an external interface unit 13a and a storage interface unit 13b.

The control unit 11 includes a divided data writing unit 11a, a divided data reading unit 11b and an operation setting unit 11c. The divided data writing unit 11a divides data stored in the primary storage 21. The divided data reading unit 11b reads out divided data pieces from the secondary storage 22 to the primary storage 21 and transfers them to the host server 3.

The operation setting unit 11c sets a size for division of data, sets a data retention time in the primary storage 21 and so on. The operation setting unit 11c sets the number of simultaneous writable/readable data pieces for determining the number of data pieces writable/readable between the primary storage 21 and the secondary storage 22.

The external interface unit 13a performs interface control over apparatuses coupled to the network 5 or the storage control unit 10, and the storage interface unit 13b performs interface control over the storage unit 20.

The control unit 11 is implemented by the processor 100 in FIG. 3, and the external interface unit 13a is implemented by the input/output interface 102 or the network interface 104 in FIG. 3. The storage interface unit 13b is implemented by the storage interface 105 in FIG. 3, and the storing unit 12 is implemented by the memory 101 in FIG. 3.

<Operations in Archive Division Mode>

Next, operations according to the embodiments will be described in detail below. Target data may be divided when the data is written to the secondary storage 22, or target data may be divided when the data is moved from the secondary storage 22 to the primary storage 21. The former will be called archive division, and the latter will be called recall division. Operations in the archive division mode will be described first.

(Flowchart)

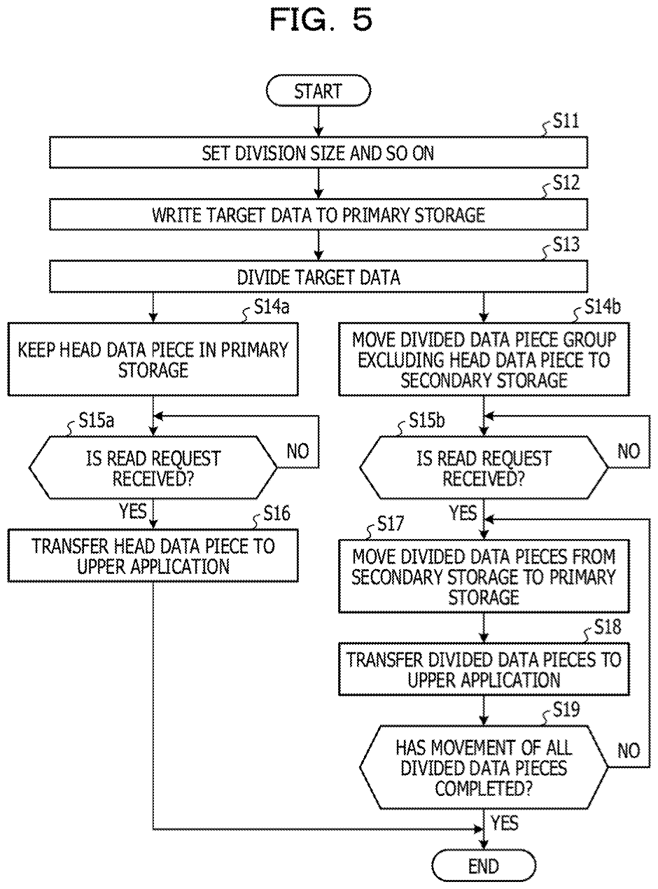

FIG. 5 is a flowchart illustrating an example of a data transfer operation in the archive division mode.

[Step S11] The control unit 11 sets a division size and so on based on timeout information (predetermined time), for example, of the upper application 3a.

[Step S12] In response to a write request from the upper application 3a, the control unit 11 writes target data to the primary storage 21.

[Step S13] The control unit 11 divides the target data into data pieces each having the set division size.

[Step S14a] The control unit 11 keeps and stores the head data piece of divided data pieces of the target data in the primary storage 21. The processing moves to step S15a.

[Step S14b] The control unit 11 moves and stores the divided data piece group excluding the head data piece to the secondary storage 22. The processing moves to step S15b. The divided data piece group is copied to the secondary storage 22 and is deleted from the primary storage 21 upon completion of the copy.

[Step S15a] The control unit 11 waits for reception of a target data read request from the upper application 3a. When the read request is received, the processing moves to step S16.

In a parallel processing branch of the data transfer operation in the archive division mode, [Step S15b] also occurs in which the control unit 11 waits for reception of a target data read request from the upper application 3a. When the read request is received, the processing moves to step S17.

[Step S16] The control unit 11 transfers the head data piece to the upper application 3a.

[Step S17] In parallel with the transfer of the head data piece, the control unit 11 moves the divided data pieces from the secondary storage 22 to the primary storage 21.

[Step S18] The control unit 11 transfers, to the upper application 3a, the divided data pieces moved to the primary storage 21.

[Step S19] The control unit 11 determines whether all of the divided data pieces have been moved from the secondary storage 22 to the primary storage 21. If divided data pieces remain in the secondary storage 22, the processing moves to step S17. If the movement of all of the divided data pieces has completed, the processing ends.

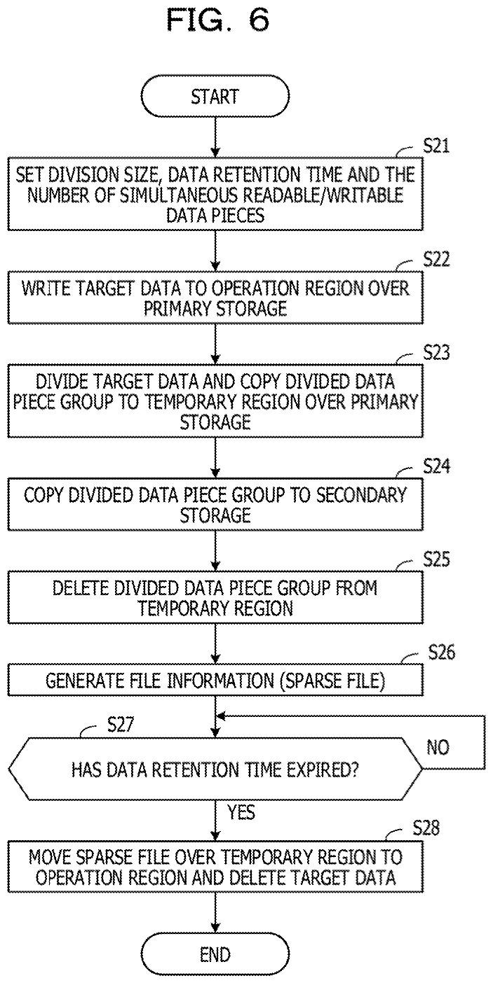

FIG. 6 is a flowchart illustrating an example of a writing operation in the archive division mode.

[Step S21] The control unit 11 sets a division size, a data retention time and the number of simultaneous readable/writable data pieces for dividing, transferring and storing target data. The data retention time is a time for retaining data In the primary storage 21. The number of simultaneous writable/readable data pieces is the number of data pieces writable/readable between the primary storage 21 and the secondary storage 22.

[Step S22] In response to a write request from the upper application 3a, the control unit 11 writes target data to the operation region 21a over the primary storage 21.

[Step S23] The control unit 11 divides the target data into data pieces each having the set division size and copies and stores the divided data piece group including the head data piece to the temporary region 21b over the primary storage 21.

[Step S24] The control unit 11 copies and stores the divided data piece group excluding the head data piece to the secondary storage 22 based on the number of simultaneous readable/writable data pieces.

[Step S25] The control unit 11 deletes the divided data piece group excluding the head data piece from the temporary region 21b.

[Step S26] The control unit 11 generates file information and stores it in the temporary region 21b.

In a case where target data is managed in files, the control unit 11 generates file information. The file information includes attributes (Sparse attributes) of the head data piece, storage destination information and a free space, and each attribute may be managed in a shortcut form, for example. The storage destination information indicates a storage destination address of the divided data piece group moved to the secondary storage 22, and the free space indicates an amount of the divided data piece group moved to the secondary storage 22.

The attribute of the free space is information indicating the existence of a free space, and a free space is not actually allocated over the primary storage 21. When the divided data piece group is reconstructed in the primary storage 21, the divided data piece group is written in the capacity indicated by the free space. The data rearrangement control is performed between the primary storage 21 and the secondary storage 22 based on the generated file information so that highly efficient data management is possible through the file information. Hereinafter, the file information will be called a “Sparse file”.

[Step S27] The control unit 11 determines whether the data retention time has expired or not. When the data retention time has expired, the processing moves to step S28.

[Step S28] The control unit 11 moves the Sparse file over the temporary region 21b to the operation region 21a and deletes the target data over the operation region 21a.

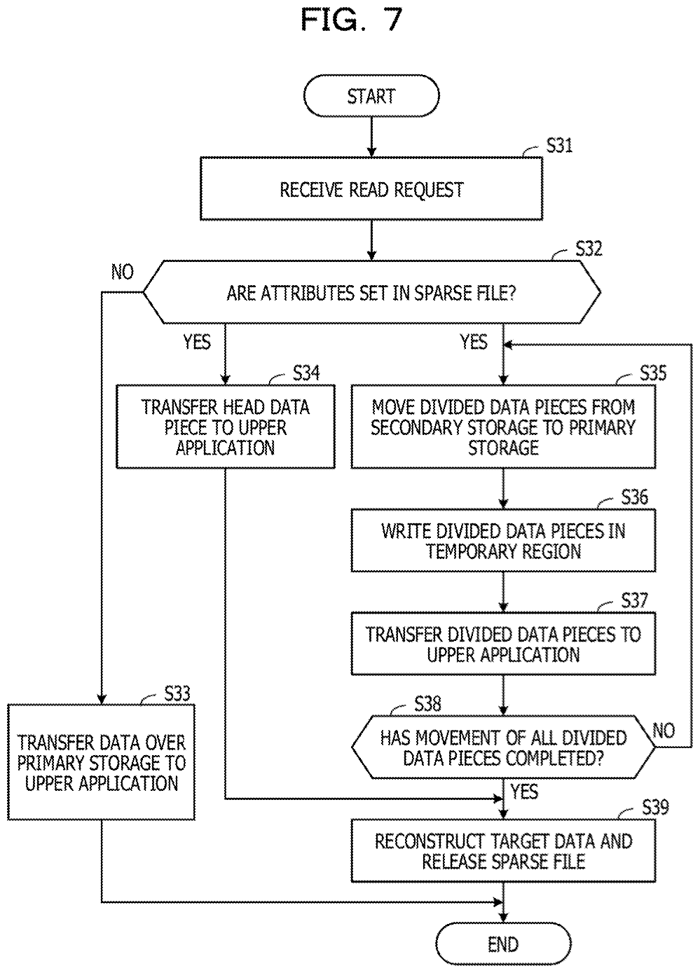

FIG. 7 is a flowchart illustrating an example of a reading operation in the archive division mode.

[Step S31] The control unit 11 receives a read request from the upper application 3a.

[Step S32] The control unit 11 determines whether the data requested to read is data having attributes set in the Sparse file or not. If the attributes are set, the processing moves to steps S34 and S35. If the attributes are not set, the processing moves to step S33.

[Step S33] The control unit 11 transfers, to the upper application 3a, the target data stored in the primary storage 21.

[Step S34] The control unit 11 transfers, to the upper application 3a, the head data piece indicated in the Sparse file. The processing moves to step S39.

[Step S35] The control unit 11 moves the divided data pieces stored in the secondary storage 22 to the temporary region 21b within the primary storage 21 based on the number of simultaneous readable/writable data pieces.

[Step S36] The control unit 11 writes the moved divided data pieces to the temporary region 21b. The processing in step S34 and the processing in steps S35 and S36 are executed in parallel.

[Step S37] The control unit 11 transfers, to the upper application 3a, the divided data pieces written in the temporary region 21b.

[Step S38] The control unit 11 determines whether all of the divided data pieces have been moved from the secondary storage 22 to the primary storage 21. If divided data pieces remain in the secondary storage 22, the processing moves to step S35. If the movement of all of the divided data pieces has completed, the processing moves to step S39.

[Step S39] The control unit 11 reconstructs the target data by joining the divided data piece group with the head data piece over the primary storage 21, cancels the Sparse file and deletes the attributes of the storage destination information and the free space within the Sparse file.

(Conceptual Images of Operation in Archive Division Mode)

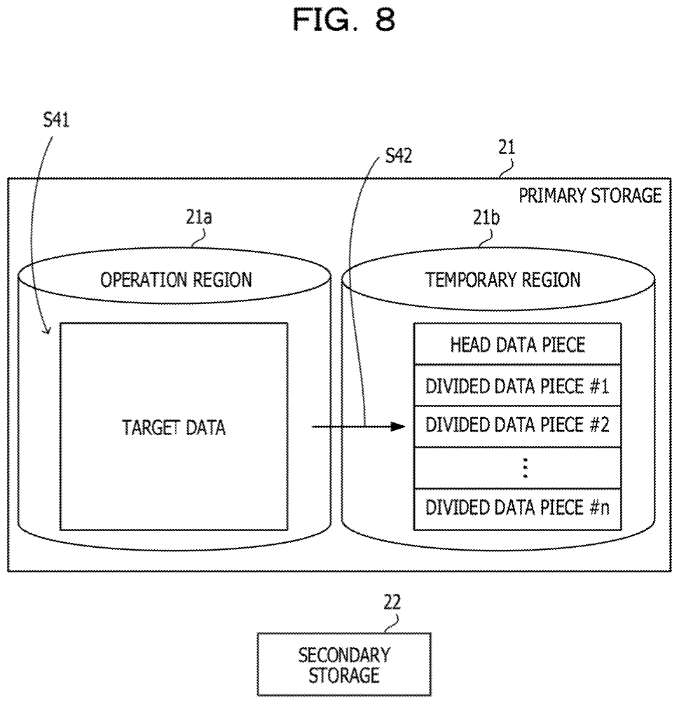

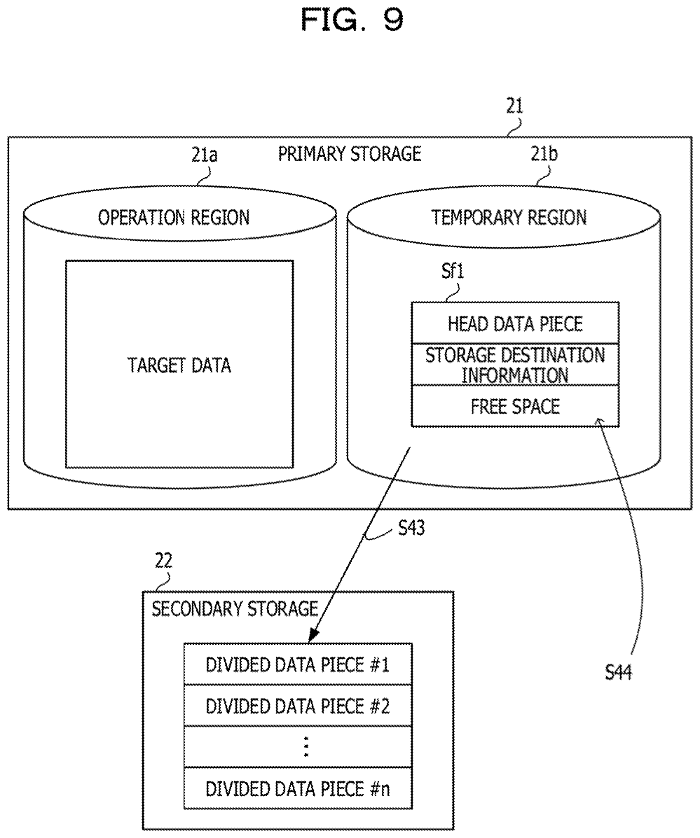

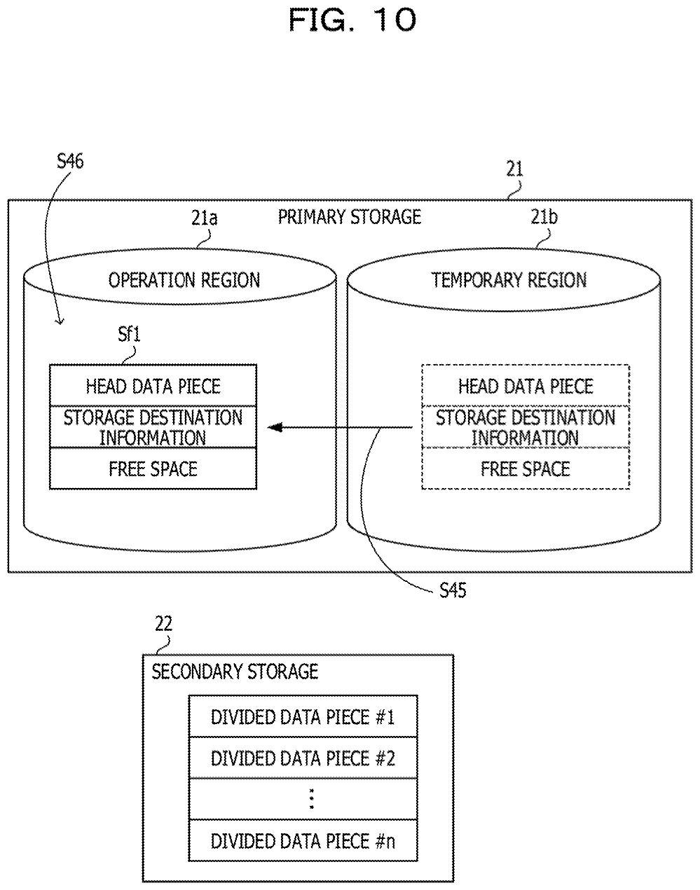

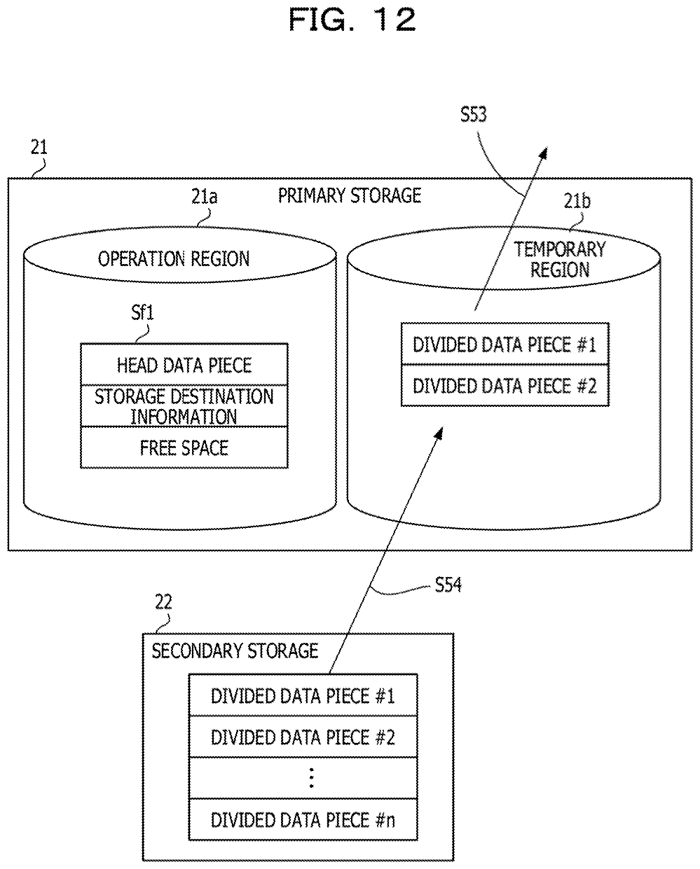

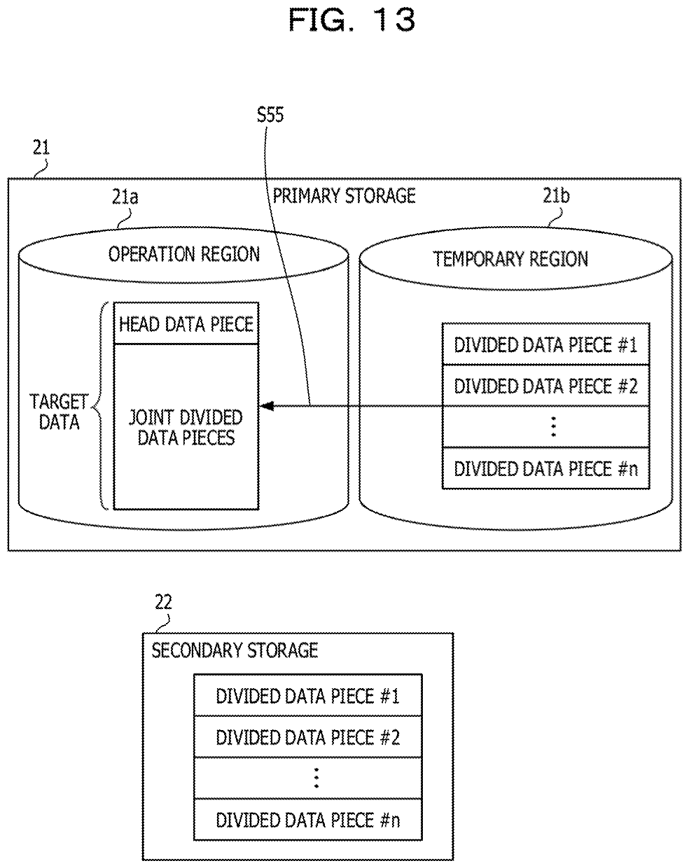

Next, conceptual images of operation in the archive division mode will be described with reference to FIGS. 8 to 13. FIGS. 8 to 10 are diagrams for explaining an example of a writing operation.

[Step S41] In response to a write request from the upper application 3a, the control unit 11 writes target data to the operation region 21a over the primary storage 21.

[Step S42] The control unit 11 divides the target data written in the operation region 21a based on the set division size and copies the divided data pieces to the temporary region 21b over the primary storage 21 as the head data piece, a divided data piece #1, . . . , # n.

[Step S43] The control unit 11 copies the divided data pieces #1, . . . , # n to the secondary storage 22 and, after completion of the copy, deletes the divided data pieces #1, . . . , # n over the temporary region 21b.

[Step S44] The control unit 11 generates a Sparse file Sf1 including attributes of the head data piece, storage destination information and a free space over the temporary region 21b. The storage destination information indicates storage destination addresses over the secondary storage 22 of the divided data pieces #1, . . . , # n moved to the secondary storage 22, and the free space indicates an amount of the divided data piece group (divided data pieces #1, . . . , # n).

[Step S45] The control unit 11 moves the Sparse file Sf1 over the temporary region 21b to the operation region 21a (after the movement to the operation region 21a, the Sparse file Sf1 is deleted from the temporary region 21b).

[Step S46] The control unit 11 deletes the target data from the operation region 21a.

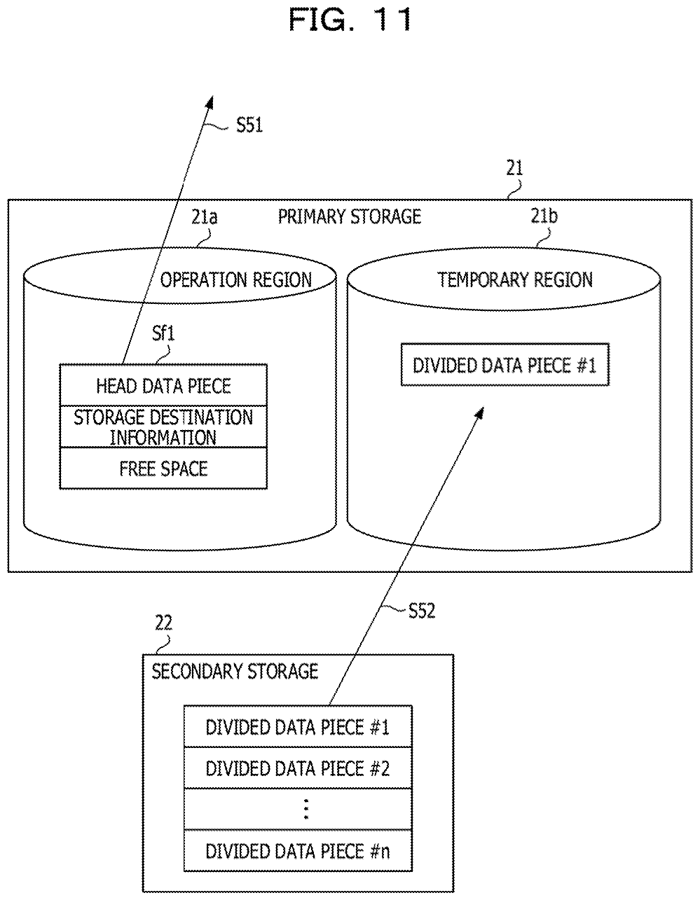

FIGS. 11 to 13 are diagrams for explaining an example of a reading operation.

[Step S51] In response to a read request from the upper application 3a, the control unit 11 transfers the head data piece included in the Sparse file Sf1 over the operation region 21a to the upper application 3a.

[Step S52] In parallel with the transfer of the head data piece, the control unit 11 copies and moves the divided data piece #1 over the secondary storage 22 to the temporary region 21b over the primary storage 21. The control unit 11 reads out the divided data piece #1 over the secondary storage 22 based on the storage destination information indicated in the Sparse file Sf1 and stores the divided data piece #1 to the free space over the temporary region 21b Indicated in the Sparse file Sf1.

[Step S53] The control unit 11 transfers the divided data piece #1 to the upper application 3a.

[Step S54] In parallel with the transfer of the divided data piece #1, the control unit 11 copies and moves the divided data piece #2 over the secondary storage 22 to the temporary region 21b over the primary storage 21. The control unit 11 reads out the divided data piece #2 over the secondary storage 22 based on the storage destination information indicated in the Sparse file Sf1 and stores the divided data piece #2 to the free space over the temporary region 21b indicated in the Sparse file Sf1.

As in steps S52 and S54 described above, by performing data rearrangement from the secondary storage 22 to the primary storage 21 based on the storage destination information and the free space managed in the Sparse file Sf1, the data movement may be efficiently performed.

[Step S55] After transferring all of the divided data pieces #1, . . . , # n over the secondary storage 22, the control unit 11 reconstructs the target data by joining the divided data pieces #1, . . . , # n with the head data piece over the operation region 21a. Because the target data requested to read are reconstructed over the primary storage 21, the data is transferred immediately from the primary storage 21 in response to a read request again, resulting in higher responsiveness. After the target data is reconstructed, the control unit 11 cancels the Sparse file Sf1 and deletes the attributes of the storage destination information and free space within the Sparse file Sf1.

<Operation in Recall Division Mode>

(Flowchart)

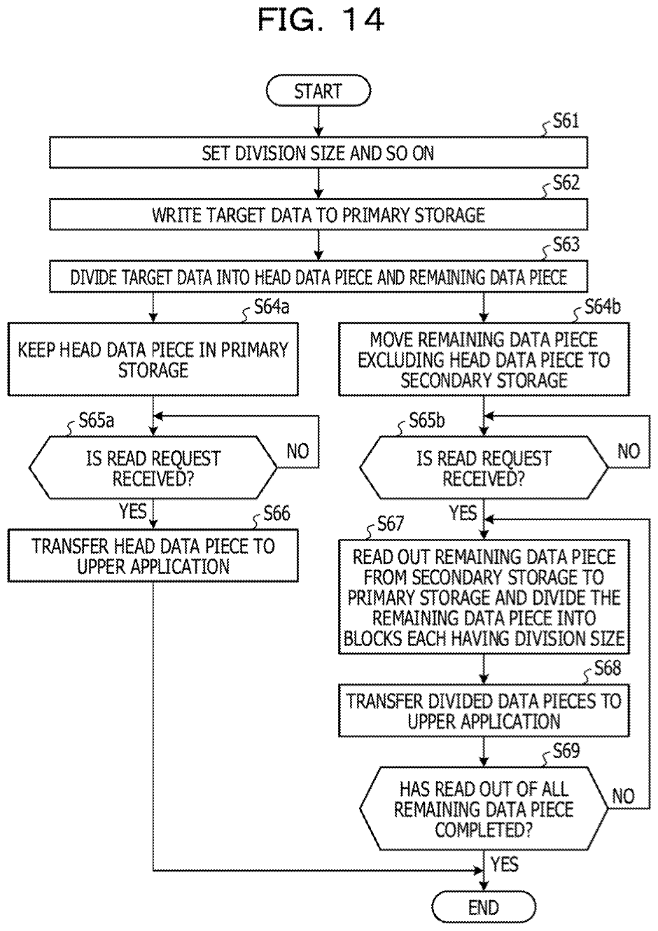

FIG. 14 is a flowchart illustrating an example of a data transfer operation in the recall division mode.

[Step S61] The control unit 11 sets a division size and so on based on timeout information, for example, of the upper application 3a.

[Step S62] In response to a write request from the upper application 3a, the control unit 11 writes target data to the primary storage 21.

[Step S63] The control unit 11 divides the target data into the head data piece and the remaining data piece excluding the head data piece.

[Step S64a] The control unit 11 keeps and stores the head data piece in the primary storage 21. The processing moves to step S65a.

[Step S64b] The control unit 11 moves and stores the remaining data piece excluding the head data piece to the secondary storage 22. The processing moves to step S65b. The remaining data piece is copied to the secondary storage 22 and is deleted from the primary storage 21 upon completion of the copy.

[Step S65a] The control unit 11 waits for reception of a target data read request from the upper application 3a. When the read request is received, the processing moves to step S66.

In a parallel processing branch of the data transfer operation in the rea division mode, [Step S65b] also occurs in which the control unit 11 waits for reception of a target data read request from the upper application 3a. When the read request is received, the processing moves to step S67.

[Step S66] The control unit 11 transfers the head data piece to the upper application 3a.

[Step S67] In parallel with the transfer of the head data piece, the control unit 11 reads out the remaining data piece from the secondary storage 22 and divides the read remaining data piece into data pieces each having a set division size and stores the divided data pieces in the primary storage 21.

[Step S68] The control unit 11 transfers the divided data pieces to the upper application 3a.

[Step S69] The control unit 11 determines whether all of the divided remaining data pieces have been moved from the secondary storage 22 to the primary storage 21. If divided remaining data pieces remain in the secondary storage 22, the processing returns to step S67. If the movement of all of the remaining data pieces has completed, the processing ends.

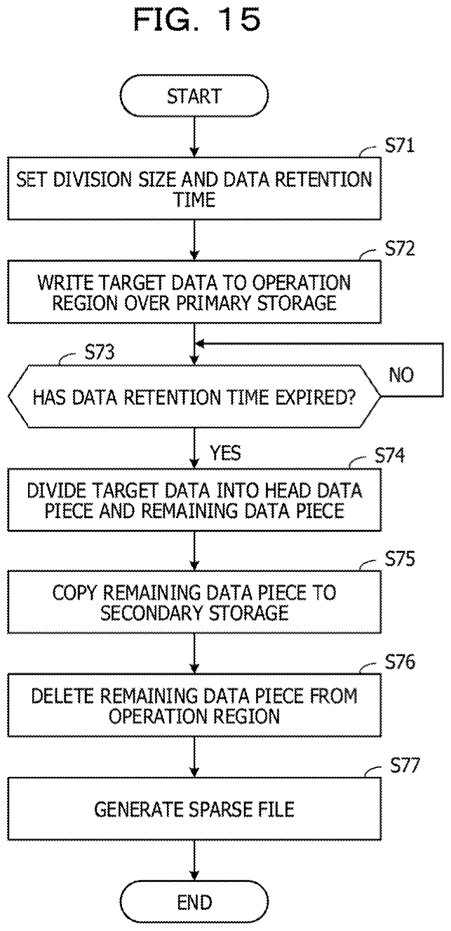

FIG. 15 is a flowchart illustrating an example of a writing operation in the recall division mode.

[Step S71] The control unit 11 sets a division size and a data retention time.

[Step S72] In response to a write request from the upper application 3a, the control unit 11 writes target data to the operation region 21a over the primary storage 21.

[Step S73] The control unit 11 determines whether the data retention time has expired or not. When the data retention time has expired, the processing moves to step S74.

[Step S74] The control unit 11 divides the target data into the head data piece and the remaining data piece.

[Step S75] The control unit 11 copies and moves the remaining data piece excluding the head data piece to the secondary storage 22.

[Step S76] The control unit 11 deletes the remaining data piece excluding the head data piece from the operation region 21a.

[Step S77] The control unit 11 generates a Sparse file including attributes of the head data piece, storage destination information and a free space over the operation region 21a and deletes the target data over the operation region 21a.

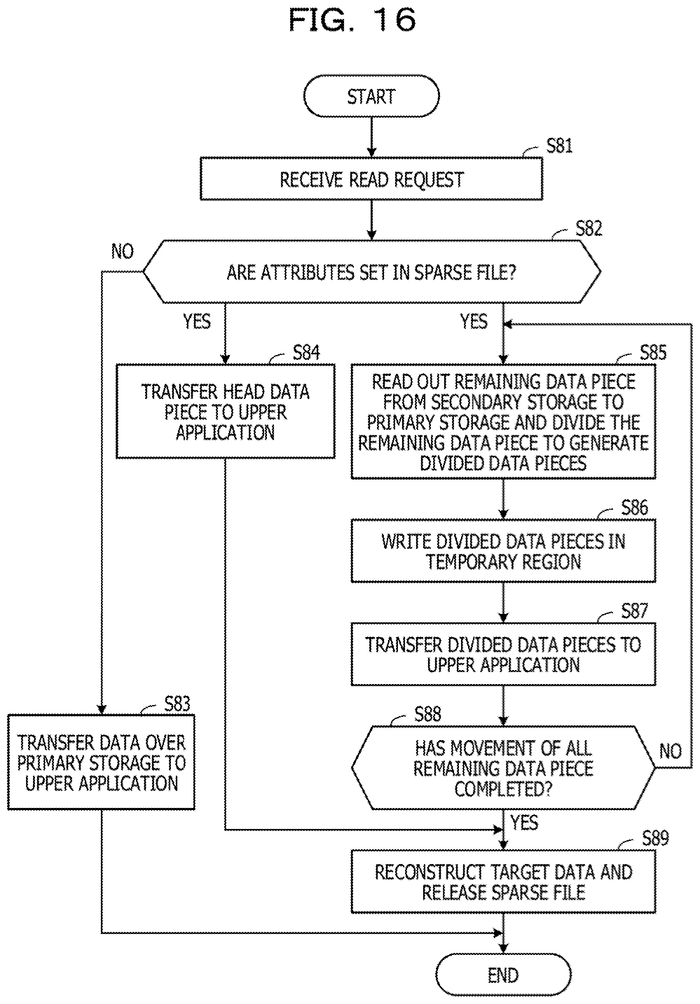

FIG. 16 is a flowchart illustrating an example of a reading operation in the recall division mode.

[Step S81] The control unit 11 receives a read request from the upper application 3a.

[Step S82] The control unit 11 determines whether the data requested to read is data having attributes set in the Sparse file or not. If the attributes are set, the processing moves to steps S84 and S85. If the attributes are not set, the processing moves to step S83.

[Step S83] The control unit 11 transfers, to the upper application 3a, the target data stored in the primary storage 21.

[Step S84] The control unit 11 transfers, to the upper application 3a, the head data piece indicated in the Sparse file. The processing moves to step S89.

[Step S85] The control unit 11 reads out the remaining data piece stored in the secondary storage 22 and divides it into data pieces each having the division size.

[Step S86] The control unit 11 writes the divided data pieces to the temporary region 21b. The processing in step S84 and the processing in steps S85 and S86 are executed in parallel.

[Step S87] The control unit 11 transfers, to the upper application 3a, the divided data pieces written in the temporary region 21b.

[Step S88] The control unit 11 determines whether all of the remaining data piece has been moved from the secondary storage 22 to the primary storage 21. If the remaining divided data pieces remain in the secondary storage 22, the processing moves to step S85. If the movement of all of the remaining divided data pieces has completed, the processing moves to step S89.

[Step S89] The control unit 11 reconstructs the target data by joining the divided data piece group with the head data piece over the primary storage 21, cancels the Sparse file and deletes the attributes of the storage destination information and the free space within the Sparse file.

(Conceptual Images of Operation in Recall Division Mode)

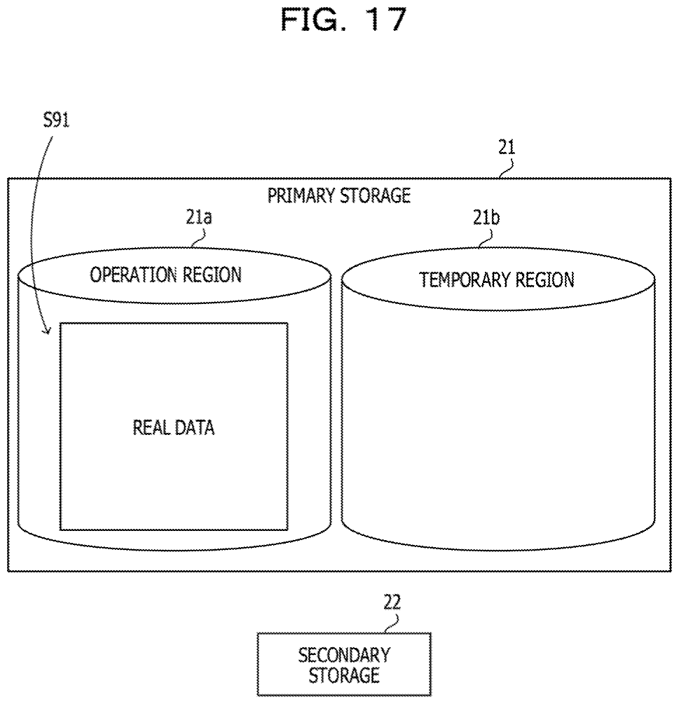

Next, conceptual images of operation in the recall division mode will be described with reference to FIGS. 17 to 20.

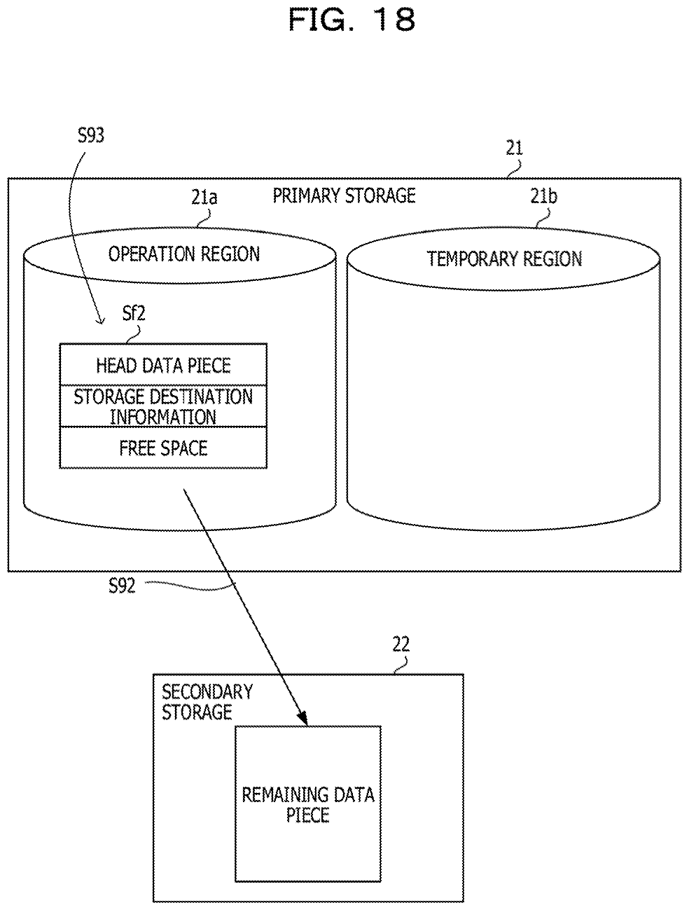

FIGS. 17 and 18 are diagrams for explaining an example of a writing operation.

[Step S91] In response to a write request from the upper application 3a, the control unit 11 writes target data to the operation region 21a over the primary storage 21.

[Step S92] The control unit 11 divides the data written to the operation region 21a into a head data piece and the remaining data piece and moves the remaining data piece to the secondary storage 22.

[Step S93] The control unit 11 generates a Sparse file Sf2 including attributes of the head data piece, storage destination information and a free space over the operation region 21a. The storage destination information indicates a storage destination address over the secondary storage 22 of the remaining data piece moved to the secondary storage 22, and the free space indicates an amount of the remaining data piece.

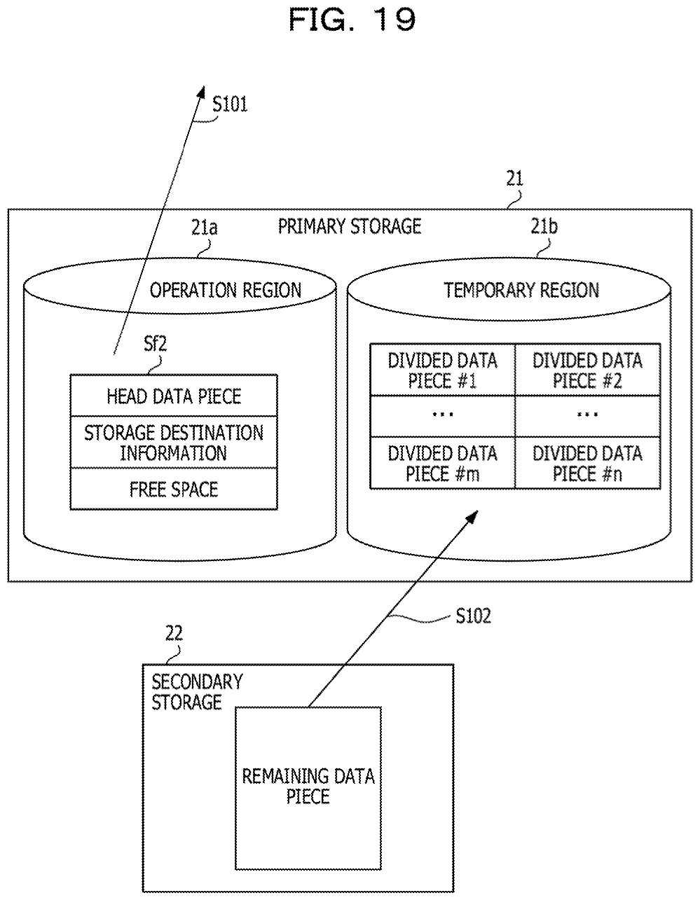

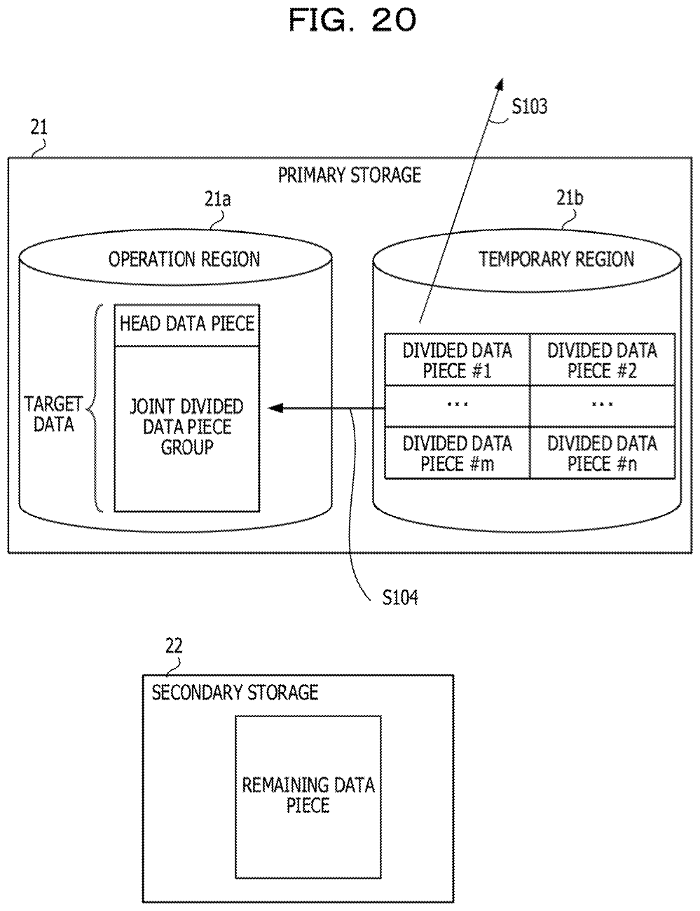

FIGS. 19 and 20 are diagrams for explaining an example of a reading operation.

[Step S101] In response to a read request from the upper application 3a, the control unit 11 transfers the head data piece over the operation region 21a to the upper application 3a.

[Step S102] In parallel with the transfer of the head data piece, the control unit 11 divides the remaining data piece into data pieces each having the division size and copies and moves the divided data pieces #1, . . . , # n to the temporary region 21b over the secondary storage 22.

[Step S103] The control unit 11 sequentially transfers the divided data pieces over the temporary region 21b to the upper application 3a.

[Step S104] After transferring all of the divided data pieces #1, . . . , # n over the secondary storage 22, the control unit 11 reconstructs the target data by joining the divided data pieces #1, . . . , # n with the head data piece over the operation region 21a. The control unit 11 cancels the Sparse file Sf2 and deletes the attributes of the storage destination information and free space within the Sparse file Sf2.

The target data is divided into a head data piece and the remaining data piece in step S63 and step S92. Regarding the data amount for dividing the head data piece, the data amount of the head data piece is set such that a timeout does not occur while the data is being transferred to the upper application 3a.

In other words, for example, the control unit 11 determines the data amount of the head data piece such that the time required for transfer of the head data piece to the upper application 3a is equal to or longer than the time required for dividing the remaining data piece and moving the divided data pieces from the secondary storage 22 to the primary storage 21. Thus, while the head data piece is being transferred, the division of the remaining data piece and the movement of the divided data pieces from the secondary storage 22 to the primary storage 21 complete. Therefore, without causing a timeout, after the transfer of the head data piece, the divided data pieces may be sequentially transferred.

(Operation After Transfer of Divided Data Piece Group)

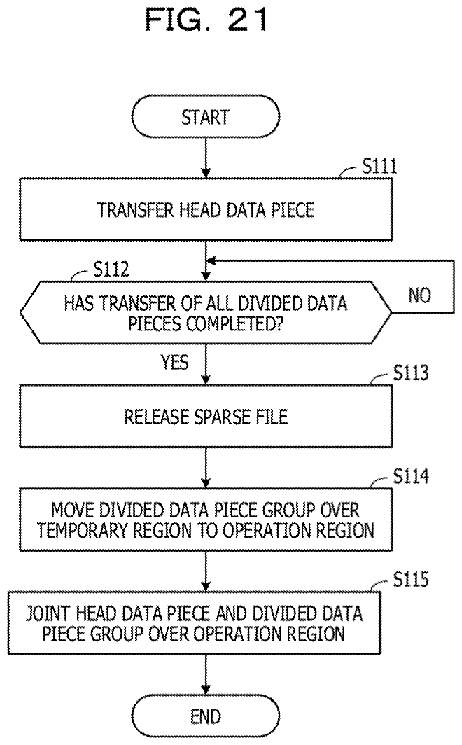

FIG. 21 is a flowchart illustrating an example of operations from transfer of a head data piece to reconstruction of target data. FIG. 21 illustrates a common operation in the archive division mode and in the recall division mode.

[Step S111] The control unit 11 transfers a head data piece to the upper application 3a.

[Step S112] The control unit 11 transfers the divided data pieces to the upper application 3a. If the transfer of all of the divided data pieces completes, the processing moves to step S113.

[Step S113] The control unit 11 cancels the Sparse file Sf2 over the operation region 21a and deletes the attributes of the storage destination information and free space within the Sparse file Sf2.

[Step S114] The control unit 11 moves the divided data piece group over the temporary region 21b to the operation region 21a and deletes the divided data piece group over the temporary region 21b.

[Step S115] The control unit 11 reconstructs the target data by joining the head data piece and the divided data piece group over the operation region 21a.

<Data Transfer Time>

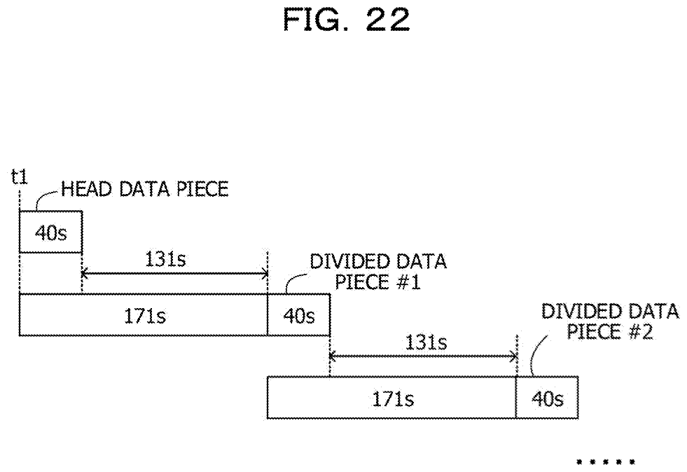

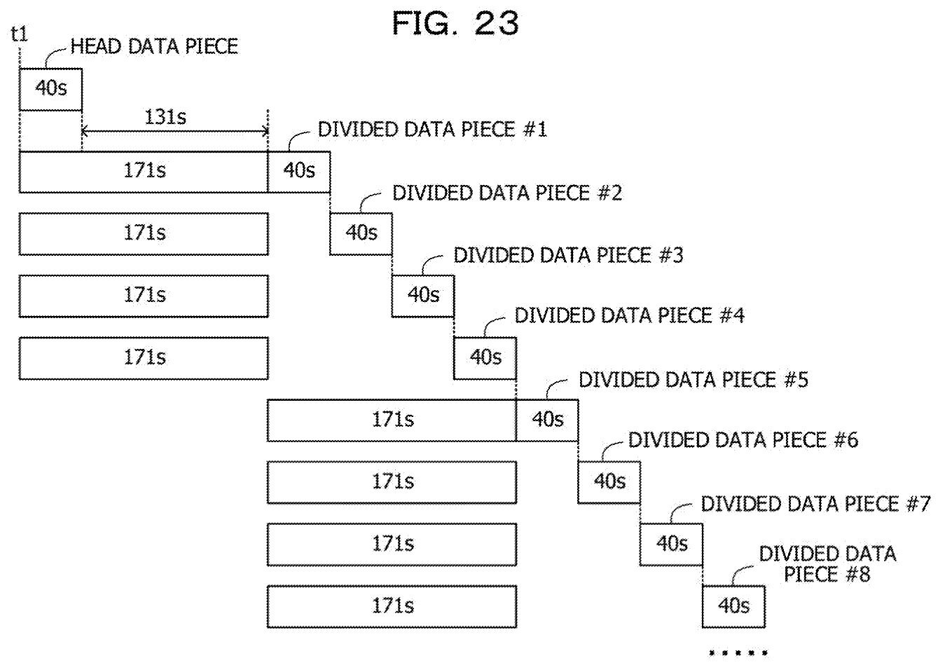

Next, a specific example of the data transfer time in the archive division mode will be described with reference to FIGS. 22 and 23. It is assumed that the data size of target data is 1 TB (1024 GB), the capacity of the operation region 21a is 30 TB, and the capacity of the temporary region 21b is 60 TB, and the processing speed for writing to the secondary storage 22 by the control unit 11 is 60 MB/sec, and the processing speed for reading therefrom is 30 MB/sec.

It is assumed that the data retention time is 24 hours, and the number of simultaneous readable/writable data pieces is equal to 4. It is assumed that the network processing speed between the host server 3 and the storage apparatus 1-1 is 1 Gb/sec, and the time out value of the upper application 3a is 180 seconds.

FIG. 22 is a diagram illustrating an example of data transfer. FIG. 22 illustrates data transfer states in a case where the secondary storage 22 is a tape. It is assumed that the division size is set as 5 GB (or the head data piece and the divided data pieces have a 5 GB data size). Because the divided data pieces are stored in order from the beginning of the tape, each one divided data piece is sequentially read out irrespective of the number of simultaneous readable/writable data pieces.

Because the network processing speed, 1 Gb/sec, means 1 Gb/sec×1024=1024 Mb/sec, data of (1024/8) MB may be transferred in one second. 5 GB means (5×1024) MB. Therefore, the transfer time of a head data piece is 40 sec as a result of calculation from the following Expression (1).

5 GB×1024/(1 Gb/sec×1024/8)=40 sec (1)

The time until the first one of the divided data pieces may be transferred, that is, the time required for the movement of the data piece from the secondary storage 22 to the primary storage 21 is equal to 171 sec as a result of calculation from the following Expression (2) because the reading processing speed of the secondary storage 22 is 30 MB/sec.

5 GB×1024/30 MB/sec=171 sec (2)

From Expressions (1) and (2), the waiting time of the upper application 3a until the first divided data piece is transferred is 131 sec (=171−40).

Referring to FIG. 22, a time t1 is a data transfer starting time. When the head data piece stored in the operation region 21a in the primary storage 21 is started to be transferred from the time t1, the completion of transfer of the head data piece takes 40 sec.

From the time t1, the divided data piece #1 is started to move from the secondary storage 22 to the primary storage 21. The movement of one divided data piece from the secondary storage 22 to the primary storage 21 requires 171 sec, and transfer of the data piece to the upper application 3a after the movement to the primary storage 21 requires 40 sec. Therefore, the waiting time of the upper application 3a from the reception of the head data piece to the reception of the divided data piece #1 is 131 sec (<180 sec). Also, the waiting time of the upper application 3a from the reception of the divided data piece #1 to the reception of the divided data piece #2 is 131 sec. Subsequently, divided data pieces are transferred continuously to the upper application 3a every 131 sec.

Because the target data has a data size of 1 TB, the number of divided data pieces #1, . . . , # n is equal to 203.8 as a result of calculation from the following Expression (3). The total data transfer time is equal to 34890 sec as a result of calculation from the following Expression (4).

1 TB×(1024/5 GB)−1=203.8 pieces (3)

40 sec+171 sec×203.8=34889.8=34890 sec (4)

On the other hand, in a general system without having the functionality of the embodiments, the time for moving data from a secondary storage to a primary storage is 34953 sec as a result of calculation from the following Expression (5).

1 TB×1024×1024/30 MB/sec=34953 sec (5)

The time for transferring 1-TB data to the upper application 3a is 8192 sec as a result of calculation from the following Expression (6).

1 TB×1024/((1 Gb/sec)/8)=8192 sec (6)

Therefore, the total data transfer time is equal to 43145 sec (=34953+8192). Comparing the embodiments and the general system, the data transfer time may be reduced by 2.3 hours (=8255 sec=43145 sec−34890 sec) without causing a timeout.

The calculation of the division size will be described below. In a case where the line speed for transferring target data to the host server 3 is V bps and when a data amount of A bytes is to be transferred by using the line, the time T1 (first time) required for the transfer is calculated from T1=8 A/V (sec) as expressed in Expression (1).

When the reading processing speed of the secondary storage 22 is R, the time T2 for reading a data amount A from the secondary storage 22 (second time: a time required for moving the data from the secondary storage 22 to the primary storage 21) satisfies T2=A/R as expressed in Expression (2).

Therefore, when the difference (T2−T1) between the time T2 and the time T1 is within the timeout time of the host server 3, the data transfer may be performed without causing a timeout. Only the data amount A is a variable value among parameters for calculating the difference (T2−T1), and the other parameters are fixed values.

Therefore, the data amount A is determined such that the value of the difference (T2−T1) fits within the timeout time of the host server 3. In other words, for example, by dividing target data by the size of the data amount A and performing the control as described above, the timeout may be suppressed.

FIG. 23 is a diagram illustrating an example of data transfer. FIG. 23 illustrates data transfer states in a case where the secondary storage 22 is a disk (such as an HOD). It is assumed that the division size is set as 5 GB (or the head data piece and the divided data pieces have a 5 GB data size). Because the number of simultaneous readable/writable data pieces=4, every four divided data pieces are read out.

The transfer time of a head data piece is 40 sec from Expression (1). The time for moving divided data pieces from the secondary storage 22 to the primary storage 21 is 171 sec as in Expression (2) though four divided data pieces are simultaneously moved. Therefore, the waiting time of the upper application 3a until the first divided data piece is transferred is 131 sec (=171−40).

Referring to FIG. 23, a time t1 is a data transfer starting time. When the head data piece stored in the operation region 21a in the primary storage 21 is started to be transferred from the time t1, the completion of transfer of the head data piece takes 40 sec.

From the time t1, the divided data pieces #1, . . . , #4 are started to move from the secondary storage 22 to the primary storage 21. The movement of four divided data pieces from the secondary storage 22 to the primary storage 21 requires 171 sec, and transfer of one divided data piece to the upper application 3a after the movement to the primary storage 21 requires 40 sec. Therefore, the waiting time of the upper application 3a from the reception of the head data piece to the reception of the divided data piece #1 is 131 sec.

Because the second to fourth divided data pieces #2, . . . , #4 have been completely read out to the temporary region 21b, they are sequentially transferred to the upper application 3a when the transfer of the first divided data piece to the upper application 3a ends. Subsequently, the same operation is performed on the divided data pieces #5, . . . , #8, and the data are transferred continuously to the upper application 3a.

When the number of divided data pieces #1, . . . , # n is 203.8 as a result of calculation of Expression (3) and is assumed as being equal to 204, 51 groups of four divided data pieces are included in 204 divided data pieces.

The movement of the divided data pieces from the secondary storage 22 to the primary storage 21 requires 171 sec, and the transfer time of the four divided data pieces to the upper application 3a is equal to 160 sec (=40 sec×4). Therefore, the entire data transfer time is 8881 sec (about 2.5 hours) as a result of calculation from the following Expression (7).

(171 sec×51)+(40 sec×4)=8881 sec (7)

On the other hand, the entire data transfer time in a general system without having the functionality of the embodiments is 43145 sec as described above. Comparing the embodiments and the general system, the data transfer time may be reduced by about 9.5 hours (=34304 sec=43145 sec−8841 sec) without causing a timeout.

The above-described processing functions of the storage apparatuses 1 and 1-1 according to the embodiments may be achieved by a computer. In this case, a program that describes details of processing to be performed by functions of the storage apparatuses 1 and 1-1 is provided. The above processing function is realized on the computer by executing the program on the computer.

The program in which the content of processing is written may be recorded on a computer-readable recording medium. Examples of the computer-readable recording medium include a magnetic storing unit, an optical disk, a magneto-optical recording medium, a semiconductor memory, and the like. Examples of the magnetic storing unit include a hard disk device (HDD), a floppy disk (FD), a magnetic tape, and the like. Examples of the optical disk include a CD-R/RW. One example of the magneto-optical recording medium is a magneto-optical (MO) disk.

When the program is to be distributed, for example, portable recording media, such as CD-ROMs, on which the program is recorded are sold. The program may be stored in a storing unit of a server computer, and the program may be transferred from the server computer to another computer via a network.

The computer executing the program stores, for example, the program recorded on the portable recording medium or the program transferred from the server computer in the own storing unit. The computer then reads the program from the storing unit thereof and executes processing according to the program. The computer may also read the program directly from the portable recording medium and execute processing in accordance with the program.

Every time the program is transferred from a server computer coupled through a network, the computer may responsively execute processing according to the received program. At least a part of the above-described processing functions may be achieved by an electronic circuit such as a DSP, an ASIC, or a PLD.

Although the embodiments have been described, the configurations of the units described in the embodiments are able to be replaced with other units having the same functions. Any other constituents or processes may be added. Any two or more configurations (features) of the aforementioned embodiments may be combined.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A storage apparatus comprising:
a first memory and a second memory; and
a processor coupled to the first memory and the second memory, and configured to:
in response to a data write request, write target data to the first memory,
during data movement from the first memory to the second memory, store first data included in the target data in the first memory, store second data obtained by excluding the first data from the target data in the second memory, and delete the second data from the first memory,
in response to a data read request from a data requesting source, read the first data from the first memory and transfer the first data to the data requesting source while moving the second data from the second memory to the first memory, and
after completion of transferring the first data to the data requesting source, transfer from the first memory to the data requesting source, the second data that has been moved to the first memory.

2. The storage apparatus of claim 1, wherein
the processor is further configured to reconstruct the target data into the first memory by joining the second data with the first data after completion of transferring the second data to the data requesting source.

3. The storage apparatus of a claim 1, wherein
the processor is further configured to:
divide the target data into three or more data pieces each having a predetermined size by setting, as the first data, a head data piece of the three or more data pieces and by setting, as the second data, a plurality of data pieces obtained by excluding the head data piece from the three or more data pieces;
store the plurality of data pieces in the second memory;
in response to the data read request, read the head data piece from the first memory, transfer the head data piece to the data requesting source while moving a first data piece of the plurality of data pieces from the second memory to the first memory;
after completion of transferring the head data piece to the data requesting source, transfer from the first memory to the data requesting source, the first data piece that has been moved to the first memory while moving a second data piece of the plurality of data pieces from the second memory to the first memory; and
after completion of transferring the first data piece to the data requesting source, transfer from the first memory to the data requesting source, the second data piece that has been moved to the first memory.

4. The storage apparatus of claim 3, wherein
when the target data is managed in files, the processor:
generates file information including attributes related to the head data piece, storage destination addresses in the second memory for storing the plurality of data pieces, and a free space of the first memory which occurs after the plurality of divided data pieces are moved from the first memory to the second memory; and
stores the generated file information in the first memory.

5. The storage apparatus of claim 4, wherein
after completion of transferring the plurality of data pieces to the data requesting source, the processor restores the target data into the first memory by joining the plurality of data pieces with the head data piece indicated by the file information.

6. The storage apparatus of claim 4, wherein
based on the storage destination addresses indicated by the file information, the processor reads the first data piece and reads the second data piece subsequent to the first data piece, and moves the plurality of data pieces from the second memory to the first memory.

7. The storage apparatus of claim 4, wherein
the processor moves the plurality of data pieces from the second memory to the first memory by storing the plurality of data pieces in the free space indicated by the file information.

8. The storage apparatus of claim 3, wherein
the processor determines a data amount that causes a difference between a first time required for transferring the data amount at a line speed at which the target data is transferred to the data requesting source and a second time required for moving the data amount from the second memory to the first memory to be within a predetermined time required for data reading by the data requesting source, sets the determined data amount as the predetermined size, and divides the target data into the three or more data pieces each having the predetermined size.

9. The storage apparatus of a claim 1, wherein,
the processor is further configured to:
set a head part of the target data as the first data, and set remaining data obtained by excluding the head part from the target data as the second data;
store the second data in the second memory;
in response to the data read request, read the first data from the first memory, transfer the first data to the data requesting source while dividing the second data into a plurality of data groups each including a plurality of data pieces, each of the plurality of data pieces having a predetermined size, and moving a first data group of the plurality of data groups from the second memory to the first memory; and
transfer, to the data requesting source, the first data group after transferring the first data to the data requesting source, and transfer, to the data requesting source, a second data group subsequent to the first data group after transferring the first data group to the data requesting source.

10. The storage apparatus of claim 9, wherein
the processor sets a data amount of the first data that causes a first time required for transferring the first data to the data requesting source to be equal to or longer than a second time required for dividing the second data into the plurality of data groups and moving the first data group from the second memory to the first memory.

11. A storage system comprising:
a host server including a first processor; and
a storage apparatus including a first memory and a second memory, and a second processor coupled to the first memory and the second memory, the second processor configured to:
in response to a data write request, write target data to the first memory,
during data movement from the first memory to the second memory, store first data included in the target data in the first memory, store second data obtained by excluding the first data from the target data in the second memory, and delete the second data from the first memory,
in response to a data read request from a data requesting source, read the first data from the first memory and transfer the first data to the data requesting source while moving the second data from the second memory to the first memory, and
after completion of transferring the first data to the data requesting source, transfer from the first memory to the data requesting source, the second data that has been moved to the first memory.

12. A non-transitory, computer-readable recording medium having stored therein a program for causing a computer to execute a process, the computer coupled to a first memory and a second memory, the process comprising:
in response to a data write request, writing target data to the first memory;
during data movement from the first memory to the second memory, storing first data included in the target data in the first memory, storing second data obtained by excluding the first data from the target data in the second memory, and deleting the second data from the first memory;
in response to a data read request from a data requesting source, reading the first data from the first memory and transfer the first data to the data requesting source while moving the second data from the second memory to the first memory; and
after completion of transferring the first data to the data requesting source, transferring from the first memory to the data requesting source, the second data that has been moved to the first memory.
